(19) United States
(12) Patent Application Publication
(10) Pub. No.: US 2021/0207772 A1
(43) Pub. Date: Jul. 8, 2021

(54) MODULAR FUELING STATION

(71) Applicant: Kontak LLC, Redmond, WA (US)

(72) Inventors: Bart Norton, Redmond, WA (US); David O'Connor, North Bend, WA (US); Damien Wilson, Redmond, WA (US)

(21) Appl. No.: 17/059,150

(22) PCT Filed: May 29, 2019
(86) PCT No.: PCT/US19/34288

§ 371 Date: Nov. 25, 2020

Related U.S. Application Data
(60) Provisional application No. 62/677,612, filed on May 29, 2018.

(51) Int. Cl. F17C 5/06; F17C 13/04

(52) U.S. Cl. CPC F17C 5/06; F17C 13/04; F17C 2201/0157; F17C 2201/018; F17C 2201/035; F17C 2203/012; F17C 2265/065; F17C 2205/0376; F17C 2205/0364; F17C 2221/012; F17C 2225/036; F17C 2227/0157; F17C 2227/0192; F17C 2270/0139

(57) ABSTRACT

A fueling station can include an outer housing comprising a housing volume, a first fluid bladder positioned within the housing volume and configured to hold a first fluid, a second fluid bladder positioned within the housing volume and configured to hold a second fluid, a first fluid conduit in fluid communication with the first fluid bladder, a second fluid conduit in fluid communication with the second bladder, a first hose positioned at least partially outside the outer housing and in fluid communication with both the first and second fluid conduits, and a bi-directional first nozzle connected to an end of the first hose opposite the first and second fluid conduits. The bi-directional first nozzle can be configured to simultaneously release fluid from the first hose and to collect fluid into the first hose. The first fluid bladder can be configured to release fluid through the first conduit in response to introduction of fluid into the second fluid bladder via the second conduit. The second fluid bladder can be configured to release fluid through the second conduit in response to introduction of fluid into the first fluid bladder via the first conduit.

### CROSS-REFERENCE TO RELATED APPLICATION(S)

The present application claims priority to U.S. Provisional App. No. 62/677,612, filed May 29, 2018, and titled “MODULAR FUELING STATION” (Attorney Docket No.: 128913-8002.US00) the entire disclosure of which is hereby incorporated by reference herein and made part of the present disclosure. The present application is also related to co-pending U.S. Non-Provisional application Ser. No. 15/826,590 filed Nov. 29, 2017, titled “INDUCTIVELY HEATED MICROCHANNEL REACTOR” (Attorney Docket No.: 128913-8001.US01); U.S. Provisional No. (62/677,649), filed May 29, 2018, titled “MULTI FREQUENCY CONTROLLERS FOR INDUCTIVE HEATERS AND ASSOCIATED SYSTEMS AND METHODS” (Attorney Docket No. 128913-8003.US00), U.S. Provisional No. (62/677,640), filed May 29, 2018, titled “SYSTEMS FOR REMOVING HYDROGEN FROM REGENERABLE LIQUID CARRIERS AND ASSOCIATED METHODS” (Attorney Docket No. 128913-8005.US00), and U.S. Provisional No. (62/677,620), filed May 29, 2018, titled “DUAL BLADDER FUEL TANK” (Attorney Docket No. 128913-8006.US00). The entire disclosures of the above-recited related applications are hereby incorporated by reference herein and made part of the present disclosure.

### TECHNICAL FIELD

The present disclosure relates to fueling stations for vehicles and other devices.

### BACKGROUND

Current distribution of hydrogen for the automobile and trucking markets is through hydrogen fueling stations. These stations can cost up to 2.7 million dollars per site. The hydrogen from these stations must to be pressurized to 10,000 psi or greater when using gaseous hydrogen. Other hydrogen fueling stations use liquid hydrogen which must be cooled to −423° F./−253° C. Special equipment and a great deal of energy are required to distribute either of these two forms of hydrogen.

### BRIEF DESCRIPTION OF THE DRAWINGS

Various embodiments are depicted in the accompanying drawings for illustrative purposes, and should in no way be interpreted as limiting the scope of the embodiments. In addition, various features of different disclosed embodiments can be combined to form additional embodiments, which are part of this disclosure.

FIG. 1 illustrates a top, right, front perspective view of an embodiment of a modular fueling station.

FIG. 2 illustrates a top, right, front, cross-sectional perspective view of the modular fueling station of FIG. 1.

FIG. 3 illustrates a front plan view of the modular fueling station of FIG. 1.

FIG. 4 illustrates a rear plan view of the modular fueling station of FIG. 1.

FIG. 5 illustrates a right-side plan view of the modular fueling station of FIG. 1.

FIG. 6 illustrates a right-side cross-sectional view of the modular fueling station of FIG. 1.

FIG. 7 illustrates a schematic representation of a fueling station with a hydrogen compressor.

FIG. 8 illustrates a cross-sectional plan view of a nozzle.

FIG. 9 illustrates a cross-sectional plan view of the nozzle of FIG. 8 with a plug in an opened position,

FIG. 10 is a cross-sectional perspective view of the nozzle of FIG. 8.

FIG. 11 is a perspective view of the nozzle of FIG. 8.

FIG. 12 is a cross-sectional perspective view of a filler neck with an inner tube displaced in the proximal direction.

FIG. 13 is a cross-sectional perspective view of the filler neck of FIG. 12, wherein the inner tube is in an installed position.

FIG. 14 is a perspective view of the inner tube of the filler neck of FIG. 12.

FIG. 15 is a perspective view of the filler neck of FIG. 12.

FIG. 16 is a cross-sectional plan view of the filler neck of FIG. 12.

FIG. 17 is a cross-sectional perspective view of the nozzle of FIG. 8 mated with the filler neck of FIG. 12.

FIG. 18 is a cross-sectional plan view of the nozzle of FIG. 8 mated with the filler neck of FIG. 12.

FIG. 19 is a perspective view of fluid flow through the outer flow paths of the nozzle of FIG. 8 and the filler neck of FIG. 12.

FIG. 20 is a plan view of the fluid flow illustrated in FIG. 19.

FIG. 21 illustrates a schematic representation of a mobile device application.

### DETAILED DESCRIPTION

In contrast to high pressure and/or low temperature traditionally required to store hydrogen, storing of a hydrogen carrier can be done at room temperature and at standard pressures. This increases the safety of handling hydrogen and makes the distribution of hydrogen more appealing than other methods commonly used. The cost of a single station using hydrogen stored on a hydrogen carrier is greatly reduced when compared to traditional hydrogen fuel stations. In some cases, the cost of a hydrogen carrier-type station is closer to the cost of a conventional fueling station for gasoline or diesel, thereby meeting the need for a cost-efficient and safe means of distributing hydrogen to a mass market. The stations can be built in a standard ISO (International Standards Organization) container. In some applications, the stations can be delivered to a prepared site and setup within one day. The stations described herein can also be capable of dispensing unspent hydrogen carrier and of collecting/extracting spent, used carrier fluid. This spent carrier may be rehydrogenated (e.g., many separate times) and redistributed for use.

### Fuel Station Overview

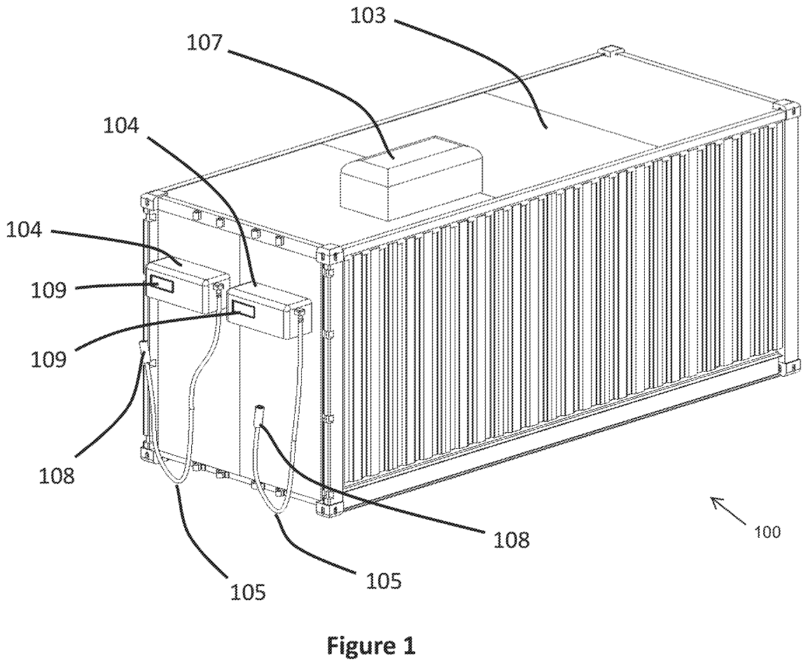

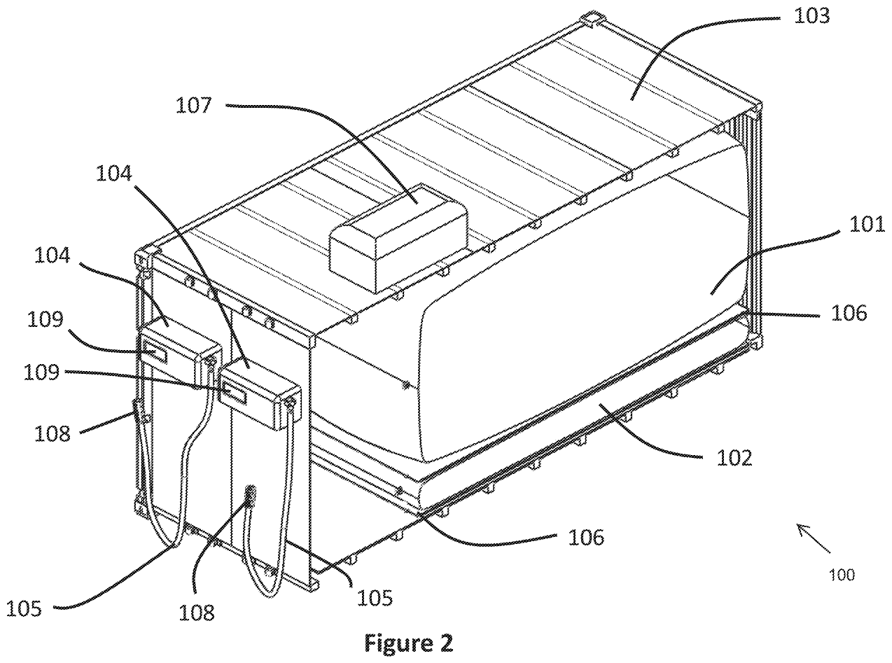

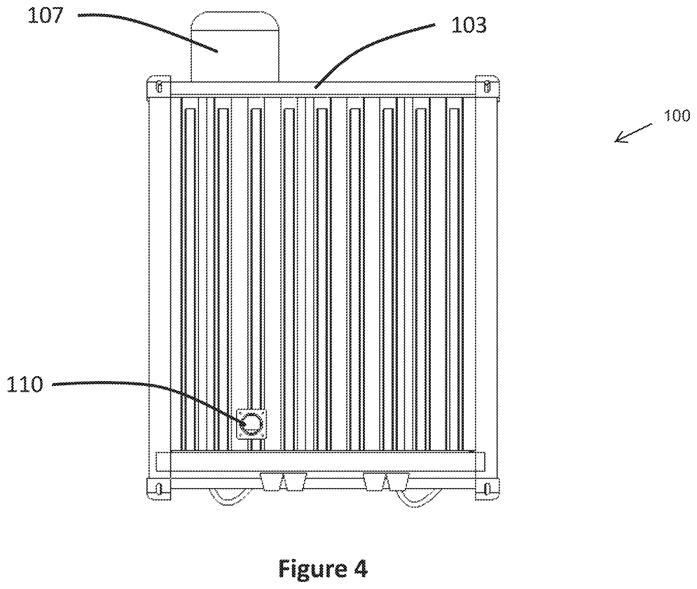

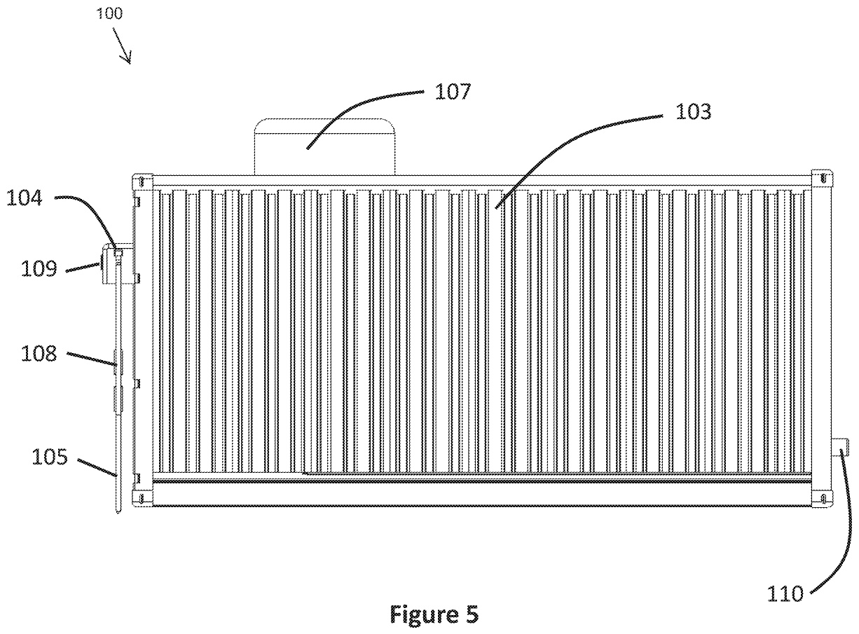

FIGS. 1 and 2 illustrate an example modular fueling station 100. The station 100 can include an outer housing 103 (e.g., the outer shell of the ISO container). Bladders 101, 102 can be positioned within the outer housing 103 to hold the fuel. One or more pumping stations 104 can be positioned on one or more sides of the outer housing 103. One or more nozzles 108 can be connected to the pumping stations 104 (e.g., via hoses 105). Preferably each fueling station 100 includes one or more point of sale terminals 109 (e.g., one terminal 109 for each pumping station 104) or other component configured to facilitate transfer of payment from a user to the owner/franchisee/provider of the fueling station 100. As illustrated in FIGS. 4 and 5, the station 100 can include one or more tank filling ports 110 configured to facilitate refilling of the station 100. In some embodiments, the station 100 includes a utility connection box 107 or other interface structure configured to facilitate interface between the fueling station 100 and other devices/components (e.g., a utility power line, data line, and/or other connection).

### Filling Station Housing

One of the advantages realized in using the fueling stations of the present disclosure is to allow a hydrogen fuel infrastructure to be built quickly and inexpensively. In some applications, a standard, factory-built fueling station design was created based on an ISO 20-foot shipping container 103. These containers measure approximately 8×8×20 feet overall (2.4×2.4×6.1 meters). In some applications, outer trim panels or other decorative structures may be attached to or otherwise used in conjunction with the container 103 to improve the aesthetic appeal of the station 100 and/or to facilitate advertising revenue.

By using a container, an inexpensive standard platform is created that can be transported by ship, rail, barge, or truck. Using a standard design allows economies of scale and reduced site-preparation costs. Not burying the station 100 in the ground allows for far quicker permitting and set-up time. In some cases, however, burying of the station 100 may be desired. For example, burying the station 100 or some components thereof may allow for greater usable space at the installation site.

The station 100 can be designed to be completely self-contained. In addition to two flexible bladders 101, 102, with a combined liquid capacity of 5,000 US gallons, the station 100 can contain between 1 and 4 (or more) dispensing pumping stations, a battery backup system, and/or a hydrogen fuel cell to charge the batteries with or without connection to an established power grid. The needed hydrogen for the fuel cells can be generated from the Kontak Hydrogen Liquid Storage Release system similar to the systems on-board vehicles (see, e.g., U.S. Non-Provisional Ser. No. 15/826,590 filed Nov. 29, 2017, titled “INDUCTIVELY HEATED MICROCHANNEL REACTOR,” the entire disclosure of which is incorporated herein by reference). In some embodiments, one or more hydrogen fuel cells are positioned within the container 103.

The capacity of the fueling station 100 in kilograms of hydrogen will depend, of course, on the carrier molecule chosen. In one example, using the molecule designated N108, the capacity is approximately 1,700 kilograms of hydrogen when converted.

In some embodiments, it may be desirable or necessary to provide thermal protection and/or active thermal controls (heating and/or cooling) to maintain the fuel cell at peak efficiency. One solution is to utilize an onboard thermal management system positioned adjacent to or within the container. The thermal management system can run from battery power, solar power, power provided from the stored hydrogen in the bladders 101, 102, and/or from another power source.

The on-board power system can be supplemented with photovoltaic solar cells or wind turbines. Excess power can be sold into the grid if a grid connection is available and the necessary options power conditioning equipment is purchased.

### Compression

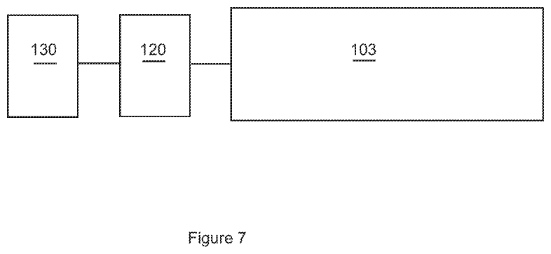

In some applications, it is desirable to provide compressed hydrogen fueling to vehicles configured to operate using compressed hydrogen. As illustrated in FIG. 7, a compressor 130 may be operably and fluidly connected to the container 103. In some designs, a compressor 130 can be built into the container 103. In some applications, the compressor 130 is positioned within a separate container or housing. A hydrogen release module 120 or other apparatus configured to release hydrogen from the fuel mixture in the bladders may be positioned in the fluid path between the container 103 and the compressor 130.

The compressor can be configured to compress hydrogen to a desired density and pressure for use with certain vehicles. For example, the compressor 130 can be capable of producing 860 BAR hydrogen (12,642 psi). This pressure is sufficient to allow timely filing of 700 BAR tanks and can be regulated down for 350 BAR fueling.

In some embodiments, hydrogen would be produced in the fueling station 100 and passed to the compressor. Depending on the demands for fueling, storage tanks would supplement the just-in-time compression (e.g., compression to meet contemporaneous demand) into vehicle tanks. Special fueling nozzles for compressed hydrogen could be used to facilitate compressed hydrogen vehicle fueling.

This method allows compressed hydrogen fueling without the expense of compressed gas transport. In most cases, it will allow at least a 60% reduction in the amount of free compressed hydrogen stored on site.

Because of the large power demands of compression, 3.2 kW/kg, mains power of 440 VAC at 30 A may be a requirement.

### Bladder System

In some applications, fluid recycling is desirable. Preferably, fluid recycling systems provide storage for the “spent” or “used” fluid (e.g., carrier fluid from which at least a portion of the usable component is removed) to be recycled. One option previously used was to provide a second, separate storage tank for collection of the spent carrier. Use of a separate tank or container can present challenges, including the need for additional space and footprint for the second container, additional piping and other fluid transfer structure, and additional weight. Each of these challenges is exacerbated in mobile applications, where space and weight are major limiting factors. Previously, capturing waste product from a process for later reuse or recycle has been cumbersome due to the cost of additional ‘wasted’ space to store it onboard and the additional handling steps and cost associated with hazmat chemicals. Additionally, redundant sensor systems were often required to separately monitor the fluid levels in the spent tank and in the unspent tank.

In the present disclosure, an advantageous solution is realized—use of two tanks in a single housing. More specifically, by mounting two flexible bladders inside the same tank, overall volume and size can remain substantially constant and spent or dehydrogenated fuel can be stored in the tank for ready re-hydrogenation. For example, as fuel or other fluid from the first bladder is used, spent carrier will be returned to the ‘spent’ tank, slowly filling as the main fuel is dehydrogenated or otherwise used. Additionally, a single sensor system or configuration may be used to monitor the fluid levels in both the spent and unspent tanks to notify the user of the station 100 when refill or re-hydrogenation is advised or required.

Returning to FIG. 2, the container 100 includes an outer housing 103. The outer housing 103 can have a hollow or partially hollow interior volume. Two or more bladders or other containers can be positioned at least partially within interior volume of the outer housing 103. For example, a first fluid bladder 101 can be positioned above a second fluid bladder 102. In some applications, this vertical arrangement is reversed. One or more air pressure bladders 106 can be positioned within the interior volume of the housing 103. As illustrated, the air pressure bladders 106 can be positioned between, above, below, and/or otherwise near the fluid bladders 101, 102. Other receptacles may be used instead of or in additional to bladders. For example, bellows, bags, pistons, or other variable-volume receptacles may be used.

Preferably, adjacent bladders within the container 100 are in contact with each other over all or substantially all of their respective surfaces that face the respective adjacent bladders. For example, as illustrated, the first bladder 101 can be positioned directly above an air pressure bladder 106. In such an arrangement, all or substantially all of the bottom surface of the first bladder 101 is in contact with all or substantially all of the top surface of the adjacent air pressure bladder 106.

In some embodiments, materials and/or manufacturing methods are used to reduce friction between adjacent bladders. For example, the outer surfaces of one or more bladders may be coated or impregnated with Teflon® or some other low-friction material. In some applications, one or more inner walls of the housing 103 may be coated or otherwise treated with low-friction materials.

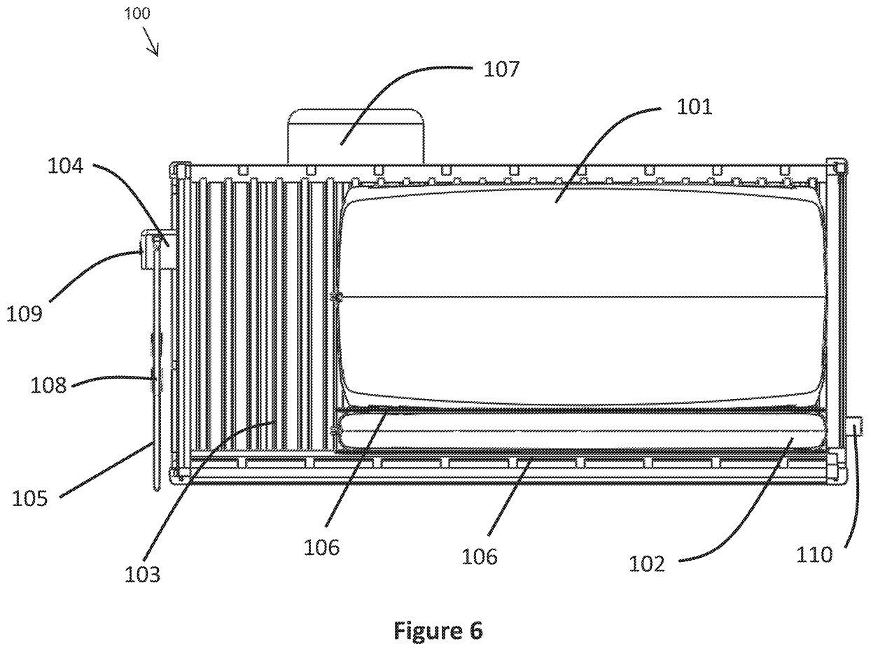

Maintaining contact between all or substantially all of the adjacent surfaces of the bladders can direct much or all of pressure forces between the bladders to a direction normal to the contact interfaces between the bladders. For example, in the illustrated arrangement of FIG. 6, each of the bladders is stacked vertically. In this arrangement, the pressure forces between the bladders is directed, for the most part, in the vertical direction (e.g., parallel to gravity in the frame of reference of FIG. 6).

In some applications, the interior of the housing 103 is open to the ambient environment. In such applications, pressure within the housing 103 is held substantially constant at the local atmospheric pressure. Preferably, the interior of the housing 103 is constructed from a rigid material and is sealed from the ambient environment and maintained at a pressure higher than the local atmospheric pressure. For example, the pressure within the housing 103 can be maintained at a level greater than both atmospheric pressure and the partial pressure of the fluids contained within the first and second bladders 101, 102. Maintaining such pressure (e.g., pressures in the range of 1-6 psi, 0-5 psi, 2-8 psi, and/or 3-15 psi) can allow the fluid within the fluid bladders 101, 102 to be maintained as a liquid, even if the fluid in the bladders 101, 102 would normally be a gas in the ambient environment.

The air pressure bladder(s) 106 can be configured to indicate the respective volumes of fluid within the first and second bladders 101, 102. For example, one or more of the air pressure bladders 106 can include an air pressure conduit (e.g., a tube or other fluid conduit) connected to a pressure sensor. Reduced pressure within an air pressure bladder 106 would indicate reduced mass within the bladders above that air pressure bladder 106. Similarly, increased pressure within an air pressure bladder 106 would indicate increased mass within the bladders above that air pressure bladder 106. In the illustrated embodiment, one air pressure bladder 106 is positioned beneath (e.g., directly beneath) the second fluid bladder 102. The other air pressure bladder 106 is positioned between the first and second fluid bladders 101, 102 in the vertical direction. In this arrangement, the relative masses of the two fluid bladders 101, 102 can be determined by measuring the difference in detected pressure within the upper and lower air pressure bladders 106. More specifically, the measured pressure in the upper air pressure bladder 106 can be used to determine the mass of fluid within the first (e.g., upper) bladder 101, which can then be subtracted from the total mass determined from the measured pressure in the lower air pressure bladder 106 to determine the mass of fluid in the second (e.g., lower) fluid bladder 102. The measured masses of the fluids within the first and second fluid bladders 101, 102 can be used to calculate the volume of fluid within each bladder. In some applications, a compressor or pump could be used to inflate or deflate one or more of the air pressure bladders 106 to adjust the internal pressure of the outer housing 103 to a desired level.

The first fluid bladder 101 can be connected to at least one tube, hose, or other fluid conduit. Similarly, the second fluid bladder 102 can be connected to one or more fluid conduits. For example, a tube can be connected to the first fluid bladder 101. The tube can facilitate fluid transfer between the first fluid bladder 101 and another component (e.g., the one or more pumping stations 104). In some embodiments, the tube can be configured to connect to a filling port, a nozzle, a compressor, a reactor, or some other component. In some embodiments, the tube is configured to connect to a hydrogen release module (HRM) configured to extract hydrogen from the fluid within the first fluid bladder. A second tube can be connected to the second fluid bladder 102. The second tube can operate with respect second fluid bladder 102 in a manner similar to or the same as the operation described above with respect to the tube connected to the first bladder. In some embodiments, the first and/or second bladders 101, 102 are attached directly to one or more of the hoses 105 of the pumping station(s) without intermediate tubes or hoses. For example, the bladders 101, 102 can include a fluid interface (e.g., a valve, nozzle, or other interface) configured to connect directly to the pumping station(s) 104 and/or hose(s) 105.

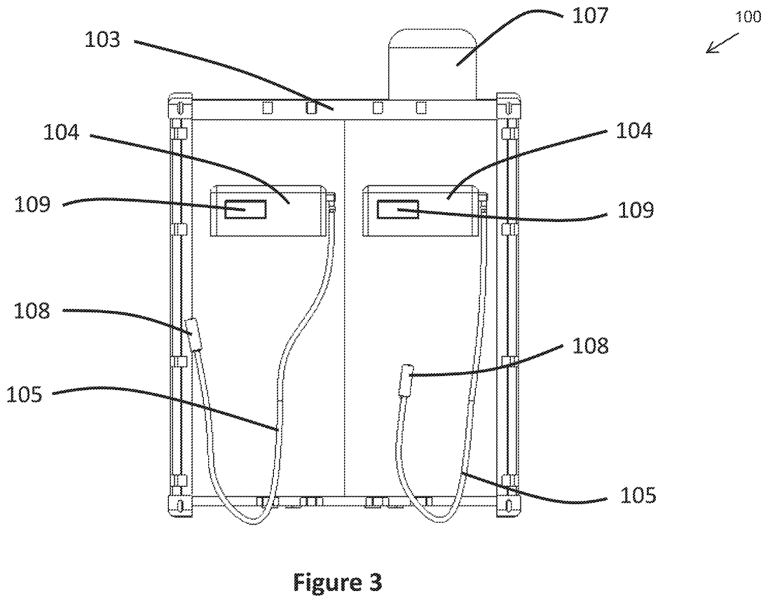

In use, the first and second bladders 101, 102 are configured to operate in conjunction with each other to maintain a constant or substantially constant cumulative volume. More specifically, as fluid is introduced to one of the bladders 101, 102 via one of the tubes, the pressure within the housing 103 is increased. Additionally, a pressure-induced force (e.g., in the vertical direction according to the orientation of the bladders in FIGS. 1-4) is applied either directly from one fluid bladder to the other, or indirectly through an intermediate air pressure bladder 106. The increased pressure within the housing 103, as well as the pressure-induced force exerted by the fluid bladder being filled, cause the other fluid bladder to contract and to release fluid via the respective tube connected to the releasing bladder. For example, as fluid is introduced into the first fluid bladder 101 via a first tube, the above-described pressure forces cause fluid to exit the second fluid bladder 102 via a second tube. In some embodiments, a pressure release valve can be configured to open in response to the above-described pressure forces to allow fluid to exit the second bladder 102. A same or similar reciprocal process occurs when fluid is introduced to the second fluid bladder 102. Use of this dual-bladder structure allows for a single container 100 with a single housing 103 to be used to both supply fluid to and collect fluid from a separate component, vehicle, tank, or other device without requiring a separate container for collecting used carrier.

Preferably, one or more check valves and/or other flow control devices are used to control the flow rates into and out from the bladders 101, 102, 106. In some embodiments, solenoid valves or other electronically-controlled flow devices are used to control fluid flow to and from the bladders. In some embodiments, a plurality of flow devices are controlled via local or remote hardware to coordinate and control flow of fluid through the bladders.

In a preferred application, the container 100 can be configured for use with hydrogen fuel. Specifically, one of the fluid bladders 101, 102 can be used to store unspent hydrogen fuel and the other bladder 101, 102 can be used to store spent carrier. Preferably, the lower fluid bladder (second bladder 102 in the illustrated embodiment) is preloaded with unspent fuel. Because the pressure head is higher for the fluid in the lower bladder than in the upper fluid bladder, a smaller, lighter, and/or more energy-efficient pump may be used to transfer fluid out from the lower fluid bladder to an HRM or other hydrogen-extraction apparatus. The bladders 101, 102 can be fluidly connected to the port 110 on the back side of the container 100 to facilitate initial filling and/or refilling of the bladders 101, 102.

### Nozzle System

Preferably, the nozzles 108 of the fueling station 100 are bidirectional. Using a bidirectional nozzle can permit simultaneous refueling of a vehicle and collection of spent carrier from the same vehicle, without requiring two separate nozzles and/or two separate ports.

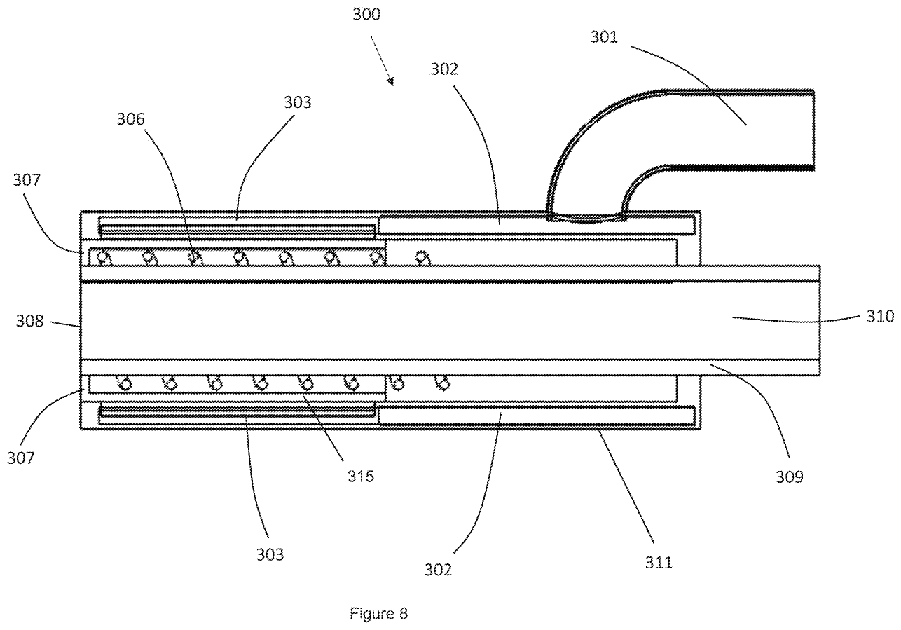

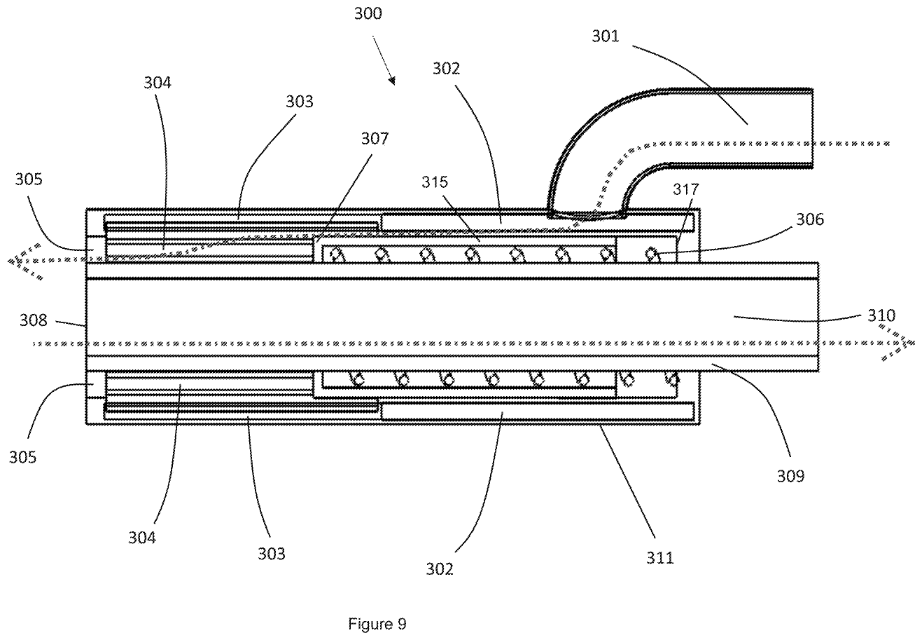

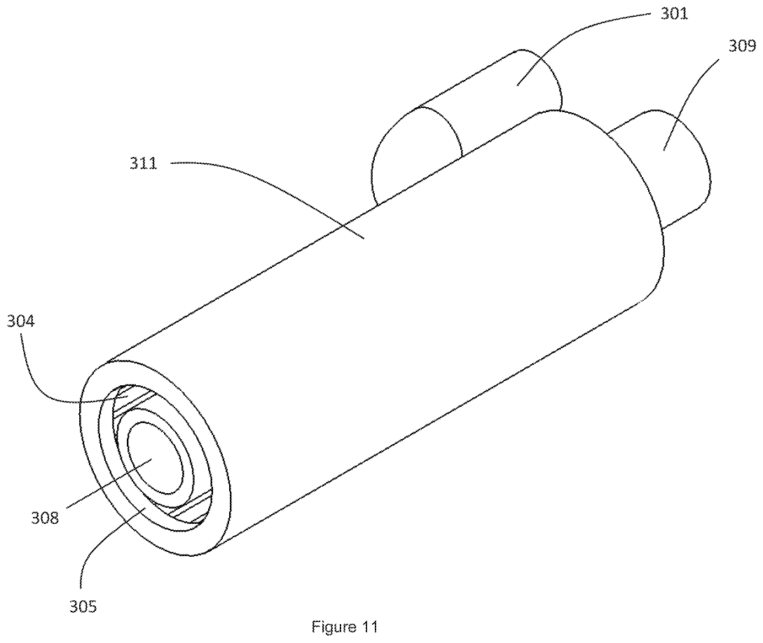

An example nozzle 300 is illustrated in FIGS. 8-11. As illustrated, the nozzle 300 can include an outer inlet port 301. The nozzle 300 can include an inner channel or tube 309. The outer inlet port 301 can be in fluid communication with an annular channel within a nozzle housing 311. The annular channel can include a proximal (e.g., nearer the modular fuel station) distribution chamber 302 and a distal (e.g., further from the modular fuel station) distribution chamber 304. The distal distribution chamber 304 can be formed from a plurality of longitudinal channels 303 defined by ribs extending inwardly from an outer wall of the annular channel. In some embodiments, the proximal and distal distribution chambers 302, 304 are in continual fluid communication with each other. In some embodiments, one or more check valves, solenoid valves, or other flow control structures are positioned between the proximal and distal distribution chambers 302, 304 to control fluid communication therebetween. The annular channel can include a distal outlet 305 (FIG. 9).

The inner tube 309 can have a proximal outlet 310 and a distal inlet 308. In some embodiments, the tube 309 defines a continuous and/or uninterrupted flow path between the outlet 310 and inlet 308. In some embodiments, one or more check valves, solenoid valves, or other flow control structures are positioned in the flow path between the outlet 310 and the inlet 308.

All or a portion of the proximal and distal distribution chambers 302, 304 can surround portions of the inner tube 309. Such a coaxial arrangement can allow for use of smaller nozzle 300 (e.g., a smaller nozzle housing 311) when compared with a nozzle having parallel noncoaxial flow channels.

In some embodiments, nozzle 300 includes a plug, shroud, or other structure configured to selectively close one or more of the inlets and outlets of the nozzle 300. For example, the nozzle 300 can include a cap (e.g., a removable cap) configured to cover the distal end of the nozzle 300 (e.g., the inlet 308 and outlet 305). In some embodiments, the cap fits on and around the distal end of the nozzle 300 via a friction fit, a threaded fit, a bayonet fit, or other mating arrangement. In some embodiments, the nozzle 300 can include a plug 315. The plug 315 can surround at least a portion of the inner tube 309 of the nozzle 300. In some embodiments, the plug 315 is configured to selectively close the outlet 305 of the annular channel to inhibit or prevent inadvertent discharge of fuel from the outlet 305. For example, the plug 315 can have an O-ring or other sealing structure 307 at or a near a distal end of the plug 315. The sealing structure 307 can be constructed from a flexible, resilient, and/or elastomeric material. In some embodiments, the sealing structure 307 is integrally formed with the remainder of the plug 315.

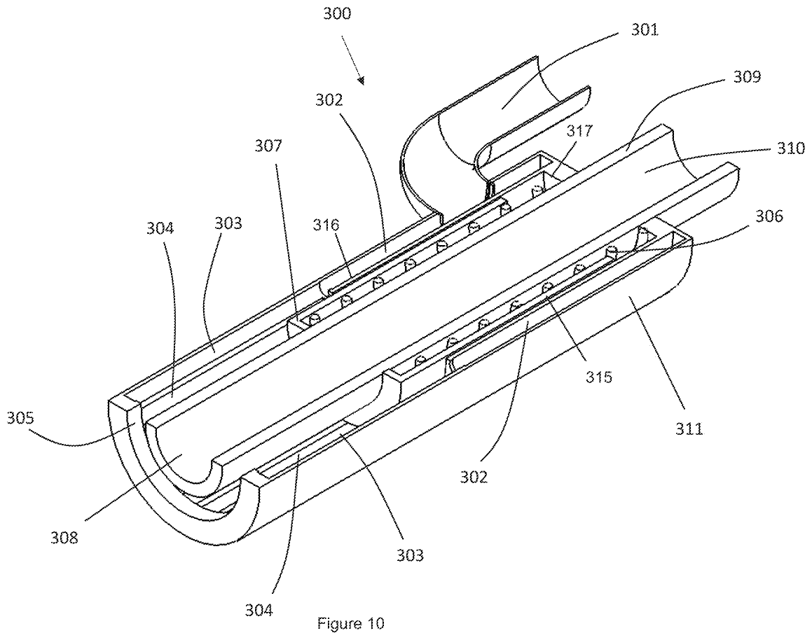

The plug 315 can be biased to a closed position wherein the sealing structure 307 seals the outlet 305 of the annular channel. A spring 306 or other biasing structure can be used to bias the plug 315 to the closed position. As illustrated, the spring 306 can surround at least a portion of the inner tube 309 of the nozzle 300. Preferably, the spring 306 is isolated from the annular channel such that the spring 306 does not come into contact with spent or unspent fuel. For example, as best illustrated in FIG. 10, the proximal distribution chamber 302 can have an inner wall 316. The inner wall 316 of the proximal distribution chamber 302 can contact the outer surface of the plug 315 to inhibit or prevent fuel passage between the plug 315 and the inner wall 316 of the proximal distribution chamber 302.

As explained in more detail below, the plug 315 can be transitioned to an opened position wherein fuel or other fluid may flow between the outlet 305 and the annular channel (e.g., the distal distribution chamber 304 of the annular channel). The proximal end of the spring 306 can abut an annular or partially annular flange or wall 317 at or near a proximal end of the nozzle 300.

As illustrated in FIG. 9, in use, hydrogenated fuel (e.g., “unspent” fuel) can enter the outer inlet port 301 and travel through the annular channel to the outlet 305 of the annular channel. Dehydrogenated (e.g., partially dehydrogenated or “spent” fuel) fuel or carrier can travel through the distal inlet 308 of the inner tube 309 and through the proximal outlet 310 of the inner tube 309. In some embodiments, these flow patterns are reversed. For example, the unspent fuel can travel through the inner tube 309 in either the proximal or distal directions, and the spent carrier can travel through the outer channel in the opposite direction.

The nozzle 300 can be configured to mate with a specific filler neck on a vehicle, tank, hydrogen release module, or other components. Various features of the filler neck and nozzle 300 can be configured to reduce the likelihood that the nozzle 300 be mated with a vehicle that is not configured to operate using the hydrogenated fuel provided by the station 100. For example, one or both of the nozzle 300 and filler neck can include keyed features, specifically-sized openings, or other designs.

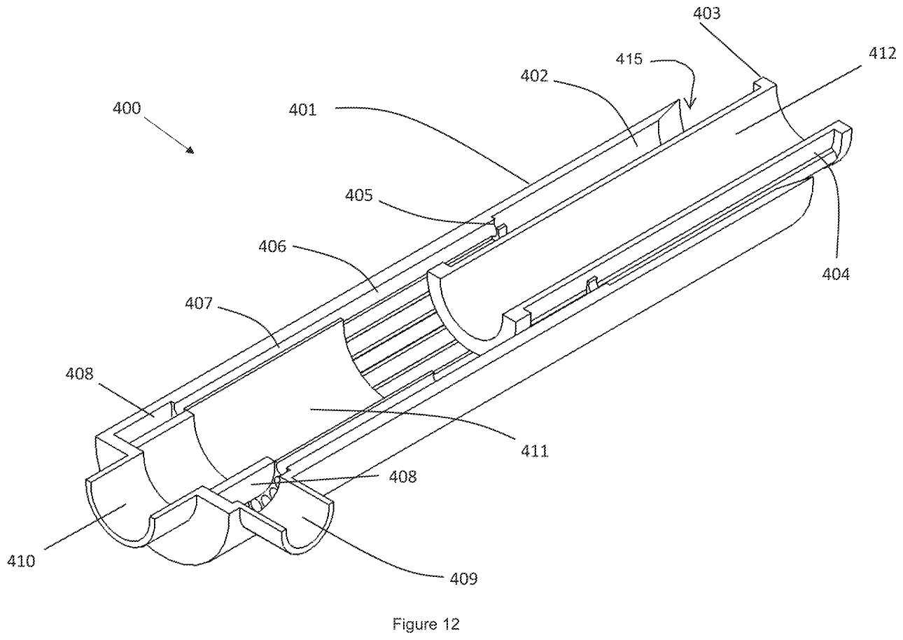

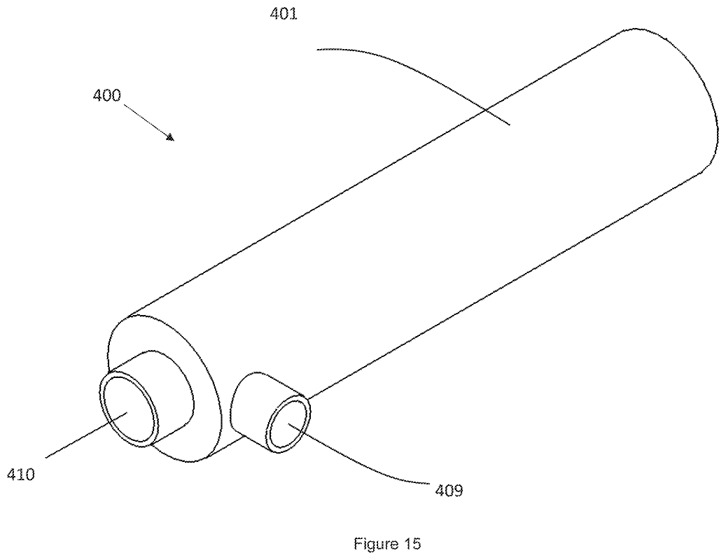

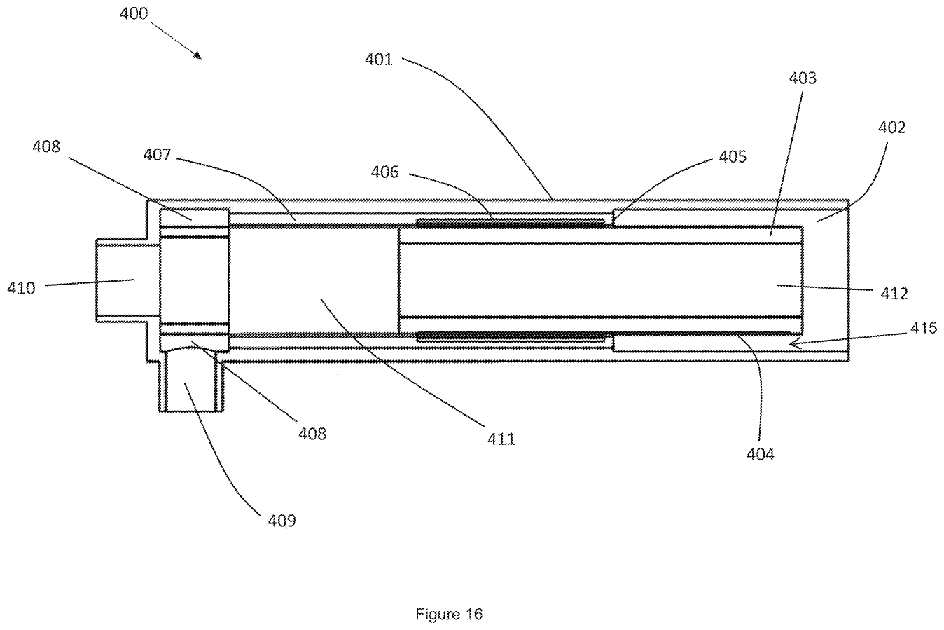

FIGS. 12-16 illustrate a filler neck 400 configured to be used with the nozzle 300. The filler neck 400 can include an inner fluid channel and an outer (e.g., coaxially-outward) fluid channel. The inner fluid channel can include an outlet 412 at a proximal end (e.g., the end closest to the nozzle 300 when mated) and an inlet 410 at a distal end (e.g., the end furthest from the nozzle 300 when mated). The outer fluid channel can include an inlet 415 at or near the proximal end and an outlet 409 at or near the distal end. In some embodiments, all or a portion of the outer fluid channel surrounds all or a portion of the inner channel.

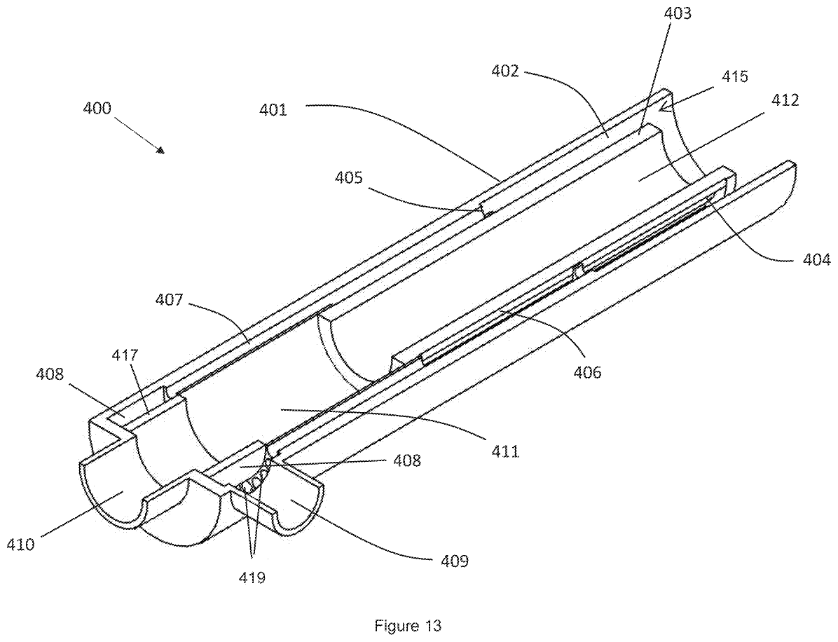

As illustrated in FIG. 13, the inner channel of the filler neck 400 can be formed from a plurality of components. For example, a proximal portion of the inner channel can be formed by an inner tube 403. The inner tube 403 can mate with a sleeve 411 to extend the inner channel in the distal direction. In some embodiments, the sleeve 411 is mated on a distal end with a collar 417. In some embodiments, one or more of the tube 403, sleeve 411, and collar 417 are formed as a single component. Fluid flow through the inner channel from the inlet 410 to the outlet 412 can be uninterrupted. In some embodiments, one or more check valves, solenoid valves, or other flow control structures are positioned within the inner channel between the inlet 410 and the outlet 412.

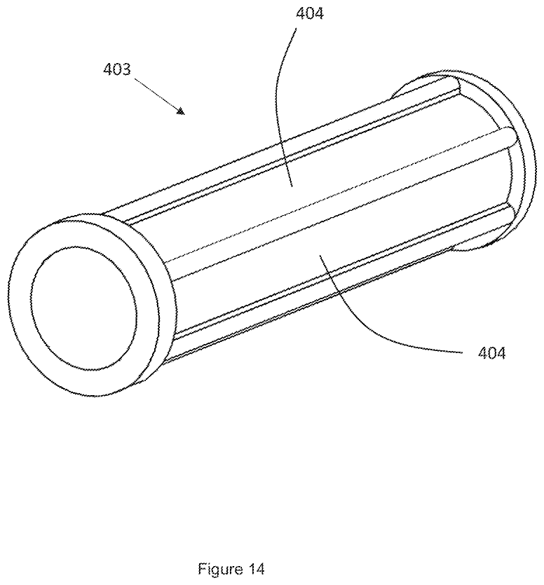

The outer channel can extend between an outer housing 401 (e.g., a proximal portion 402 of the outer housing 401) of the filler neck 400 and one or more of the components of the inner channel. For example, the inlet 415 of the outer channel can be defined by the space between the proximal end of the inner tube 403 and the inner wall of the outer housing 401. The outer channel can continue along the outer wall of the inner tube 403. In some embodiments, as illustrated in FIG. 14, the inner tube 403 can include one or more longitudinal channels 404 formed between one or more ribs on an outer surface of the tube 403. The outer housing 401 of the filler neck 400 can include one or more ribs and internal longitudinal channels 406. As illustrated in FIG. 12, wherein the inner tube 403 is displaced in the proximal direction for illustrative purposes, the internal longitudinal channels 406 can coincide with the outer channels 404 of the tube 403 along at least a portion of the length of the filler neck 400.

As illustrated in FIG. 13, the outer flow channel can continue from the longitudinal channels 404 along an outer wall of the sleeve 411. In some embodiments, the sleeve 411 includes one or more longitudinal channels 419 or conduits that extend through the wall of the sleeve 411. The collar 417 or other structure can define an annular or partially annular distal chamber 408. Flow the outer portion of the sleeve 411 can enter the chamber 408 and exit through the outlet 409 of the outer flow channel. While the outlet 409 of the outer flow channel is illustrated as extending radially outward from the length of the filler neck 400, in some embodiments, the outlet 409 extends parallel to or substantially parallel to the length of the filler neck 400.

While the fluid flow paths are described above using components 409 and 415 as inlets and components 410 and 412 as outlets, the opposite arrangement may be used (e.g., components 410 and 412 being outlets, while components 409 and 415 are outlets). Preferably, the vehicle in which the filler neck 400 is installed includes a cap, septum, or other cover to protect the proximal end of the filler neck 400 (e.g., the end with the inlet 415 and outlet 412) when the filler neck 400 is not in use.

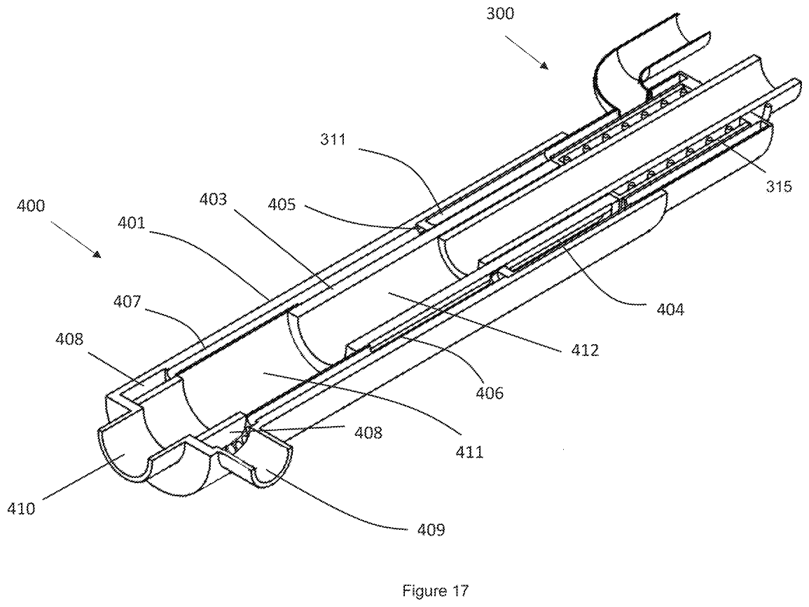

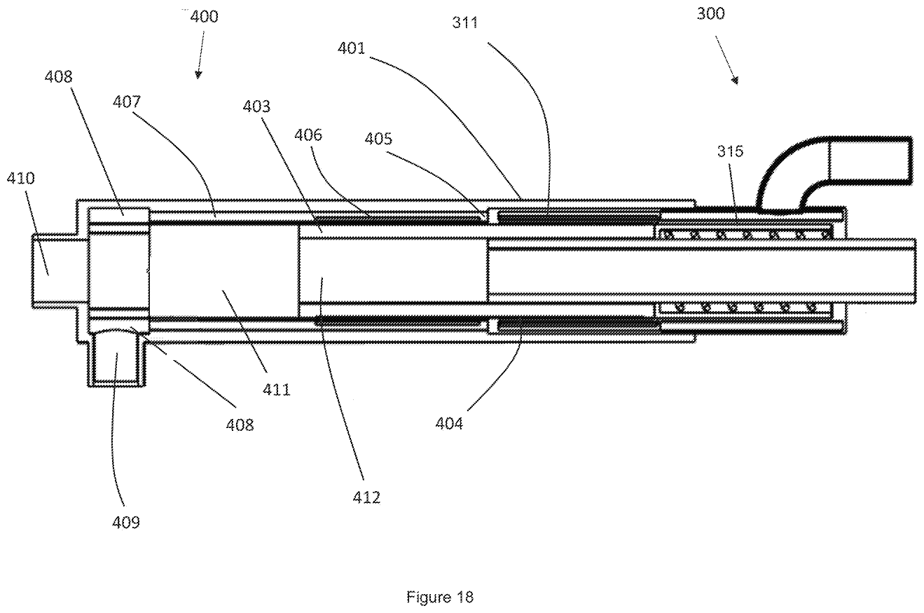

As illustrated in FIGS. 17 and 18, the nozzle 300 and filler neck 400 can be configured to mate with each other. More specifically, the distal end of the nozzle 300 can be configured to mate with the proximal end of the filler neck 400. When mated, one or more portions of the nozzle 300 and filler neck 400 can fit around, within, and/or against each other.

In the illustrated embodiment, the outer housing 311 of the nozzle 300 is sized to fit within the proximal end of the outer housing 401 of the filler neck 400. As the outer housing 311 of the nozzle 300 is moved in the distal direction with the respect to the filler neck 400, the inner tube 403 of the abuts the plug 315 of the nozzle 300. Further advancement of the nozzle 300 moves the plug 315 in the proximal direction with respect to the outlet 305 of the nozzle 300, thereby opening the outlet 305 of the outer channel of the nozzle 300. In some embodiments, longitudinal movement of the nozzle 300 with respect to the filler neck 400 is limited by abutment of the outer housing 311 of the nozzle against an internal shoulder 405 of the filler neck 400.

When mated, the inner channels of the nozzle 300 and filler neck 400 can extend coaxially with each other. The outer channels of the nozzle 300 and filler neck 400 can continue in a flow path outside of the inner channels. More specifically, flow exiting the outlet 305 of the nozzle 300 can continue along the outside surface of the tube 403 and flow to the outlet 409 in a manner consistent with that described above.

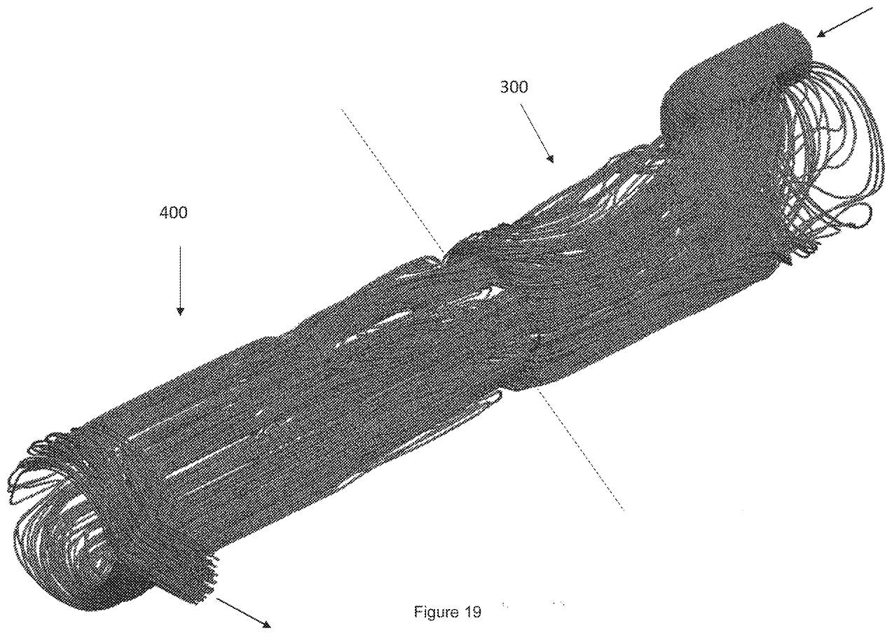

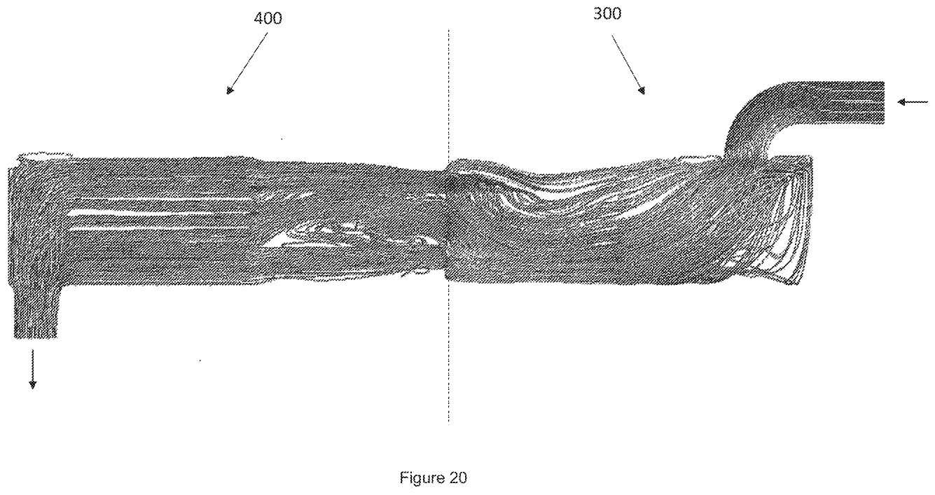

FIGS. 19 and 20 illustrate the flow path of the unspent fuel from the inlet of the outer channel of the nozzle 300 to the outlet of the outer channel of the filler neck 400. As explained above, the flow can be reversed such that fluid enters the outer channel of the filler neck 400 and exits the outer channel of the nozzle 300.

In some embodiments, the nozzle 300 and/or filler neck 400 can include one or more clips, magnets, detent structures, and/or other releasable connection structures configured to inhibit accidental disconnection between the nozzle 300 and filler neck 400 when in use. In some embodiments, one or more visual indicators (e.g., lights, displaceable components, buttons, etc.) provide confirmation to the user that the nozzle 300 and filler neck 400 are fully mated. In some embodiments, the nozzle 300 includes an outer shroud configured to collect vapors that may escape during transfer of fuel between the nozzle 300 and filler neck 400.

In some embodiments, one or both of the nozzle 300 and the filler neck 400 include (e.g., on or in the nozzle/filler neck) communication components such as near field communication (NFC) components, RFID components, Bluetooth® components, and/or other components configured to convey information to other electronic devices. Such components can be configured, for example, to communicate the type and/or grade of fuel dispensed by the nozzle 300. In some such cases, communication components on the nozzle 300 and filler neck 400 can be configured to confirm that the fuel provided by the nozzle 300 is acceptable for the vehicle being refueled. In some embodiments, communication components on the nozzle 300 and/or filler neck 400 can be configured to convey performance indicators for the fueling station 100. For example, a communication component of the nozzle 300 can be configured to convey fuel flow rate (e.g., as measured by one or flow rate sensors in one or more fuel lines, weight sensors measuring weight change rates of one or more of the bladders, and/or other sensors or instruments configured to measure fuel flow rate). In some embodiments, the communication component of the nozzle 300 can be configured to convey the quantity of unspent fuel available in one or more of the bladders of the fueling station.

### Internet Connectivity

Each of the fueling stations 100 may be connected to the internet. Internet connectivity can allow for processing of credit card transactions and other financial operability. Various fueling station statuses (e.g., quantify of unspent fuel, power remaining in fuel cell, etc.) can be communicated to one or more remote users via the internet or some other communications protocol. GPS or other positioning methods may be used to allow a user to observe the statuses of the stations 100 in conjunction with the geographic location of those stations.

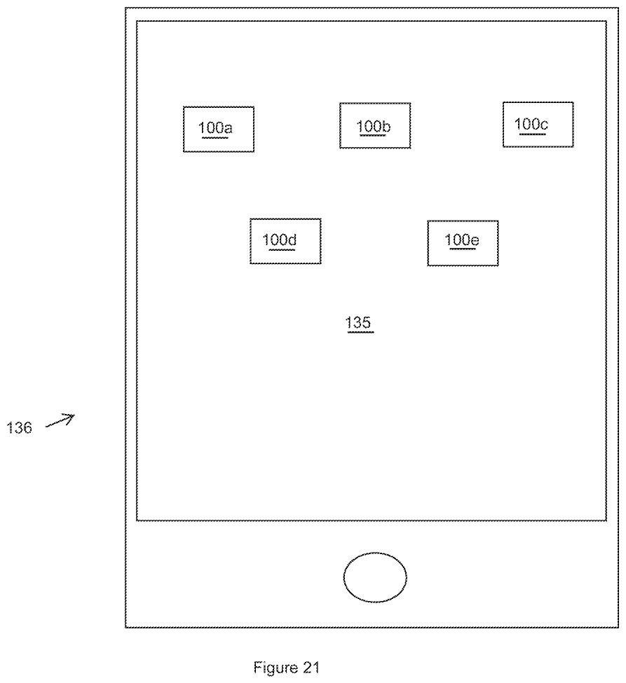

Users of the fueling stations 100 can utilize a mobile app, website, or other visual program to observe the statuses of the various fueling stations 100 in a desired geographic area. For example, as illustrated in FIG. 21, a mobile device 136 (e.g., a table, phone, laptop, watch, VR display, augmented reality display, etc.) can display the locations of one or more stations 100a, 100b, 100c, 100d, 100e in a map area 135. Various statuses of the stations can be displayed to the user. Those statuses can include the amount of fuel available, the rate of refueling at the station, the estimated travel time to the station, whether the station is within range of the user's vehicle, the scheduled refueling of the station, the number of vehicles in queue at the station, whether the station has any available compressed hydrogen, and/or the price differential between green hydrogen and SMR hydrogen. In some embodiments, status information on the mobile device 136 can be provided by the communication component on or in a nozzle of the fueling station. The above information can be used by the application to determine which stations are likely to have available fuel for the user given the location and capacity of the station. In some cases, the stations on the map 135 may be labelled with status indicator to indicate whether the station is usable for the given user. For example, the stations can be given a color designation (e.g., green means available for refueling, red means unavailable, and various shades of yellow indicate statuses between certainly available and certainly unavailable). In some embodiments, the mobile device 136 is used as a means of payment for refueling. In some embodiments, a financial account is associated with the user's vehicle such that payment is automatically deducted from an account when the vehicle is refueled.

From the foregoing, it will be appreciated that specific embodiments of the invention have been described herein for purposes of illustration, but that various modifications may be made without deviating from the scope of the invention. For example, non-ISO containers may be used as containers without deviating from the overall functionality of the fueling station 100. Accordingly, the invention is not limited except as by the appended claims.

1. A fueling station comprising:
an outer housing comprising a housing volume;
a first fluid bladder positioned within the housing volume and configured to hold a first fluid;
a second fluid bladder positioned within the housing volume and configured to hold a second fluid;
a first hose positioned at least partially outside the outer housing and in fluid communication with both the first and second bladders; and
a bi-directional first nozzle connected to an end of the first hose opposite the first and second bladders, the bi-directional first nozzle configured to simultaneously release fluid from the first hose and to collect fluid into the first hose;
wherein:
the first fluid bladder is configured to release fluid to the first hose in response to introduction of fluid into the second fluid bladder; and
the second fluid bladder is configured to release fluid through the first hose in response to introduction of fluid into the first fluid bladder.

2. The fueling station of any of claim 1, further comprising a first air bladder positioned between and in contact with the first fluid bladder and with the second fluid bladder, the first air bladder comprising a first air conduit.

3. The fueling station of claim 2, further comprising a second air bladder positioned between and in contact with the second fluid bladder and with a wall of the outer housing.

4. The fueling station of claim 2, further comprising a pressure sensor in communication with the first air bladder, wherein the first air conduit is configured to provide fluid communication between the first air bladder and the pressure sensor.

5. (canceled)

6. The fueling station of claim 3, further comprising a second pressure sensor in communication with the second air bladder, wherein the second air bladder comprises a second air conduit configured to provide fluid communication between the second air bladder and the second pressure sensor.

7. (canceled)

8. The fueling station of claim 1, further comprising:
a first fluid conduit in fluid communication with the first bladder; and
a second fluid conduit in fluid communication with the second bladder;
wherein:
the first fluid bladder is configured to release fluid through the first conduit to the first hose in response to introduction of fluid into the second fluid bladder via the second conduit; and
the second fluid bladder is configured to release fluid through the second conduit in response to introduction of fluid into the first fluid bladder via the first conduit.

9. The fueling station of claim 8, wherein the first fluid bladder comprises a third fluid conduit configured to facilitate fluid transfer between the first fluid bladder and a fluid source and a fourth fluid conduit configured to facilitate fluid transfer between the second fluid bladder and a fluid source.

10. (canceled)

11. The fueling station of claim 9, wherein the third fluid conduit has a smaller cross-sectional area than the first fluid conduit and wherein the fourth fluid conduit has a smaller cross-sectional area than the second fluid conduit.

12. (canceled)

13. The fueling station of claim 9, wherein the third fluid conduit is coaxial with the first conduit and/or the fourth fluid conduit is coaxial with the second fluid conduit.

14. (canceled)

15. The fueling station of claim 1, wherein the second fluid bladder is configured to be preloaded with unspent hydrogen on a liquid carrier, and wherein the second fluid bladder is positioned beneath the first fluid bladder.

16. The fueling station of claim 1, further comprising one or more wireless signal emitters configured to emit information to a network indicating an amount of unspent fuel remaining in the station and the location of the station.

17. The fueling station of claim 1, further comprising a local power source positioned within, on, or adjacent the outer housing.

18. The fueling station of claim 17, wherein the local power source comprises a battery, at least one solar cell, and/or a hydrogen fuel cell.

19. (canceled)

20. (canceled)

21. The fueling station of claim 1, further comprising:
a hydrogen compressor configured to compress hydrogen produced by the fueling station to a desired pressure; and
a hydrogen release module configured to extract hydrogen for fluid within one or both of the first and second bladders;
wherein the hydrogen compressor is configured to compress hydrogen extracted by the hydrogen release module.

22. (canceled)

23. (canceled)

24. The fueling station of claim 22, wherein the hydrogen compressor is configured to compress hydrogen to a pressure of at least 700 bar and/or wherein the first hose has a plurality of internal lumens and is configured to accommodate contemporaneous bidirectional flow through the hose.

25. (canceled)

26. A method of storing and distributing fluid, the method comprising:
storing unspent fluid in a first fluid bladder;
positioning the first fluid bladder within a rigid enclosure;
positioning a second fluid bladder within the rigid enclosure;
withdrawing unspent fluid from the first fluid bladder via a first fluid conduit connected to the first fluid bladder;
introducing spent fluid to the second fluid bladder via a second fluid conduit connected to the second fluid bladder;
wherein:
introducing spent fluid to the second fluid bladder occurs at a same time as withdrawing unspent fluid from the first fluid bladder;
a total volume of both the first and second fluid bladders remains substantially constant during withdrawal of unspent fluid from the first fluid bladder;
a pressure within the rigid enclosure remains substantially constant during withdrawal of unspent fluid from the first bladder.

27. The method of claim 26, wherein introducing spent fluid to the second fluid bladder expands a volume of the second fluid bladder, and wherein expanding the volume of the second fluid bladder applies a compressive pressure to the first fluid bladder to contract the first fluid bladder.

28. (canceled)

29. A fuel nozzle comprising:
an outer housing having a proximal end, a distal end, and a length extending from the proximal end to the distal end;
a first inlet at the proximal end of the outer housing;
a first outlet at the distal end of the outer housing;
a first flow path extending between the first inlet and the first outlet;
a plug configured to transition between an opened position and a closed position, wherein the plug is biased to the closed position;
a second inlet at the distal end of the outer housing;
a second outlet at the proximal end of the outer housing;
a second flow path extending between the second inlet and the second outlet; wherein:
the plug is configured to inhibit fluid flow from the first inlet to the first outlet when the plug is in the closed position;
the plug is configured to permit fluid flow from the first inlet to the first outlet when the plug is in the opened position;
a majority of the first flow path extends coaxially with and surrounds the second flow path;
a majority of the first flow path overlaps the second flow path in a direction parallel to the length of the outer housing.

30. The fuel nozzle of claim 29, comprising a spring configured to bias the plug to the closed position.

31. The fuel nozzle of claim 29, wherein the first inlet is positioned radially outward from the second outlet with respect to the length of the outer housing.

32. A fueling assembly comprising:
the nozzle of claim 29;
a filler neck configured to mate with the nozzle, the filler neck comprising:
an outer housing having a proximal end, a distal end, and a length extending between the proximal and distal ends of the outer housing of the filler neck;
an inner flow tube positioned at least partially within the outer housing of the filler neck and defining an inner flow path, the inner flow tube having an inlet at the distal end of the outer housing of the filler neck and an outlet at the proximal end of the outer housing of the filler neck;
an outer flow path surrounding at least a portion of the inner flow tube and having an inlet at the proximal end of the outer housing and an outlet at the distal end of the outer housing;
wherein:
the proximal end of the outer housing of the filler neck is configured to receive the distal end of the nozzle therein;
the inner flow tube is configured to abut the plug of the nozzle and to transition the plug from the closed position to the opened position when the nozzle is mated with the filler neck.

33. The fueling assembly of claim 32, wherein the first flow path of the nozzle is in fluid communication with the outer flow path of the filler neck when the nozzle is mated with the filler neck and/or wherein the second flow path of the nozzle is in fluid communication with the inner flow path of the filler neck when the nozzle is mated with the filler neck.

34. (canceled)

35. The fueling assembly of claim 32, further comprising a first communication component on or in the nozzle and/or a second communication component on or in the filler neck, wherein one or both of the first communication component and the second communication components is a near field communication component, and wherein the first communication component is configured to communicate a type and/or grade of fluid configured to be delivered through the nozzle

36. (canceled)

37. (canceled)

38. (canceled)
